(19) United States
(12) Patent Application Publication
(10) Pub. No.: US 2025/0321416 A1
(43) Pub. Date: Oct. 16, 2025

(54) GALVANOMETER AND LIDAR

(71) Applicant: SUTENG INNOVATION TECHNOLOGY CO., LTD., Shenzhen (CN)

(72) Inventors: Fanya LI, Shenzhen (CN); Fuming QIN, Shenzhen (CN)

(73) Assignee: SUTENG INNOVATION TECHNOLOGY CO., LTD., Shenzhen (CN)

(21) Appl. No.: 19/176,103

(22) Filed: Apr. 10, 2025

(30) Foreign Application Priority Data
Apr. 12, 2024 (CN) 202410448183.7

(51) Int. Cl. G02B 26/10; G01S 7/481

(52) U.S. Cl. CPC G02B 26/105; G01S 7/4817

(57) ABSTRACT

The present application provides a galvanometer and a LiDAR. The galvanometer includes: a fixed base, the fixed base having a first hollow area; a support frame, where the support frame is arranged in the first hollow area, the support frame is connected to the fixing seat through a first axis, and the support frame is provided with a second hollow area; and a reflector, where the reflector is arranged in the second hollow area, and the reflector is connected to the support frame through a second axis. At least one of the first axis and the second axis is a bending axis.

### CROSS-REFERENCE TO RELATED APPLICATION

The present application claims the benefit of priority to Chinese Patent Application No. 202410448183.7, filed on Apr. 12, 2024, which is hereby incorporated by reference in its entirety.

### TECHNICAL FIELD

The present application relates to the field of laser detection technology, and in particular to a galvanometer and a LiDAR.

### BACKGROUND

LiDAR is a radar system that emits laser beams to detect the position, speed, and other characteristic quantities of target objects. In recent years, the application of galvanometers in LiDAR has become a development trend. A galvanometer is a micro-mirror with advantages such as small size, high oscillation frequency and without rotating components.

With the widespread application of LiDAR, higher demands are being placed on its performance, such as the need to achieve larger scanning field of view and longer detection ranges, which requires the galvanometer to provide larger torsion angles. However, a larger torsion angle also means a greater structural stress, which will affect the reliability of the galvanometer.

### SUMMARY

The present application provides a galvanometer and a LiDAR, aiming to make the galvanometer have better reliability when providing larger torsion angles.

In a first aspect, an embodiment of the present application provides a galvanometer, which includes: a fixed base, the fixed base having a first hollow area; a support frame, the support frame is arranged in the first hollow area, the support frame is connected to the fixed base through a first axis, and the support frame is provided with a second hollow area; and a reflector, the reflector is arranged in the second hollow area, and the reflector is connected to the support frame through a second axis, where at least one of the first axis and the second axis is a bending axis.

In an embodiment of the present application, at least one of the first axis and the second axis of the galvanometer is a bending axis. Without reducing the area of the reflector, the bending axis has a larger length than the straight axis. Therefore, the length of the first axis and/or the second axis can be increased. In this way, when the galvanometer provides larger torsion angles, the structural stress on the first axis and/or the second axis can be reduced, thereby making the galvanometer have better reliability.

In some embodiments, the bending axis includes a first segment, a second segment, a third segment, a fourth segment, a fifth segment, a sixth segment, and a seventh segment connected in sequence; the first segment, the third segment, the fifth segment, and the seventh segment are all straight segments and extend along the first direction; along the first direction, the third segment and the fifth segment are both located between the first segment and the seventh segment; along the second direction, the first segment and the seventh segment are both located between the third segment and the fifth segment, and the second direction is perpendicular to the first direction.

In some embodiments, the second segment, the fourth segment, and the sixth segment are all straight segments and extend along the second direction.

In some embodiments, the second segment and the sixth segment are both straight segments and extend along the second direction; the fourth segment includes a first sub-segment, a second sub-segment, and a third sub-segment connected in sequence, the first sub-segment is connected to the third segment, the third sub-segment is connected to the fifth segment, the first sub-segment and the third sub-segment are straight segments and extend along the second direction; and along the first direction, the third sub-segment is located between the second segment and the first sub-segment.

In some embodiments, the second sub-segment is a straight segment, and the angle between the second sub-segment and the first sub-segment is greater than or equal to 135° and less than or equal to 165°.

In some embodiments, the connection parts between any two adjacent segments are formed with rounded corners.

In some embodiments, the minimum distance between the second segment and the fourth segment along the first direction is not less than 25 μm; and/or the minimum distance between the fourth segment and the sixth segment along the first direction is not less than 25 μm.

In some embodiments, the minimum distance between the second segment and the fourth segment along the first direction is not less than 50 μm; and/or the minimum distance between the fourth segment and the sixth segment along the first direction is not less than 50 μm.

In some embodiments, the second segment, the fourth segment and the sixth segment are all straight segments, the angle between the second segment and the first segment is greater than 90°, the angle between the fourth segment and the third segment is greater than 90°, and the angle between the sixth segment and the fifth segment is greater than 90°; and the second segment is parallel to the sixth segment.

In some embodiments, the bending axis includes a first segment, a second segment and a third segment connected in sequence. A first bending angle is formed between the first segment and the second segment, and a second bending angle is formed between the second segment and the third segment. The first bending angle and the second bending angle are both less than 90°.

In some embodiments, the galvanometer has a first central axis, the first central axis passes through the center of the reflector, and the first axis extends along the first direction; and the first segment and the third segment are located on opposite sides of the first central axis.

In some embodiments, the first segment has a first end away from the reflector, the third segment has a second end close to the reflector, the maximum distance between the first end and the first central axis is L₁, the maximum distance between the second end and the first central axis is L₂, and the length of the bending axis along the first direction is L₃, then L₁, L₂, L₃ satisfy the relationship: 0.5L₃<L₁<L₃; 0.5L₃<L₂<L₃.

In some embodiments, the width of the first segment gradually decreases from the end away from the second segment to the end close to the second segment; the width of the third segment gradually decreases from the end away from the second segment to the end close to the second segment; and the width of the second segment gradually decreases from the middle to both ends.

In a second aspect, an embodiment of the present application provides a LiDAR, and the LiDAR includes the galvanometer in any of the above embodiments.

### BRIEF DESCRIPTION OF DRA WINGS

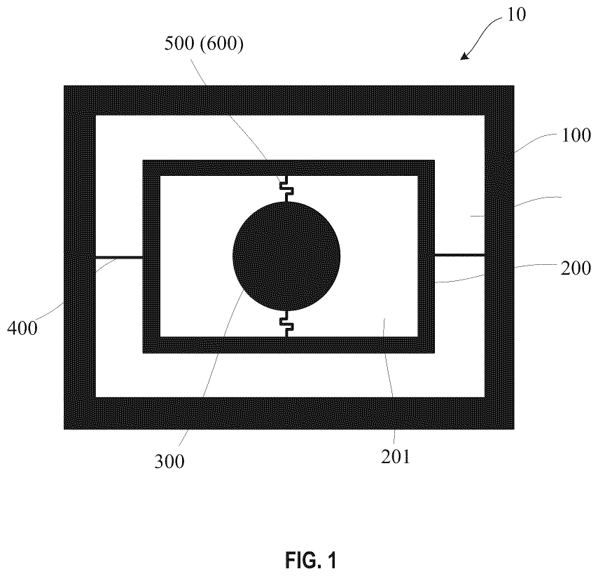

FIG. 1 is a schematic diagram of the structure of a galvanometer disclosed in an embodiment of the present application;

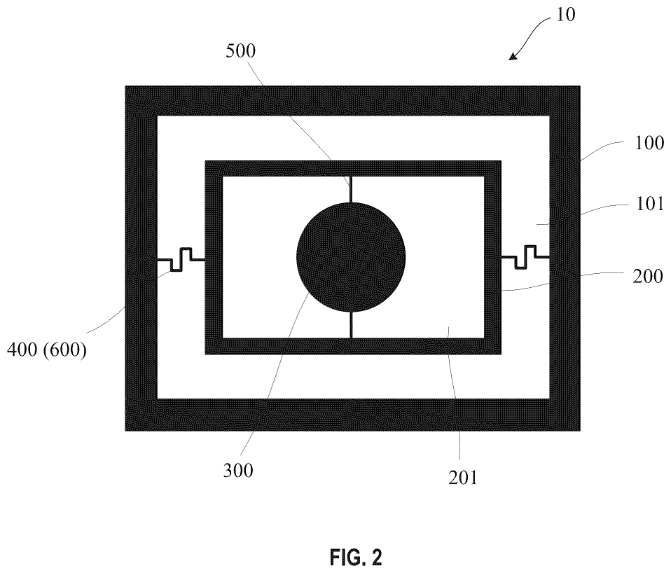

FIG. 2 is a schematic diagram of the structure of a galvanometer disclosed in an embodiment of the present application;

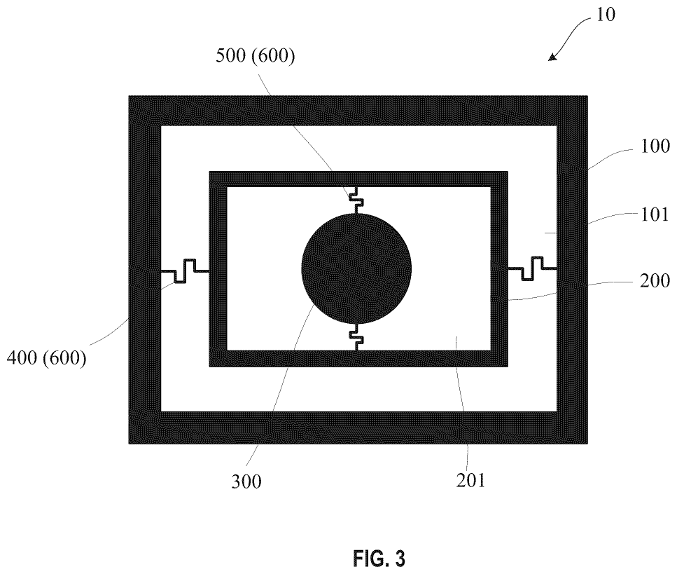

FIG. 3 is a schematic diagram of the structure of a galvanometer disclosed in an embodiment of the present application;

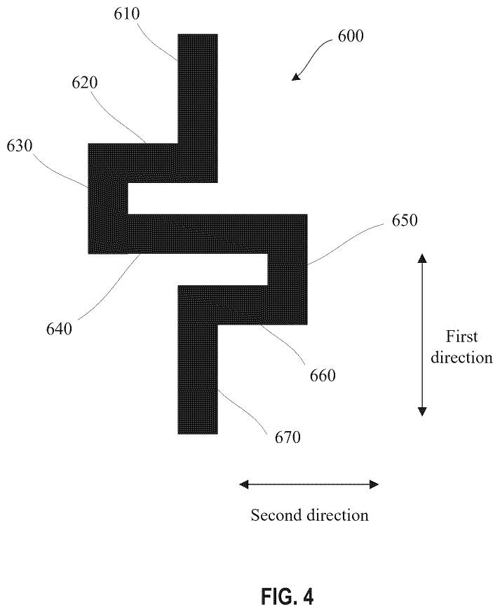

FIG. 4 is a schematic diagram of the structure of a bending axis disclosed in an embodiment of the present application;

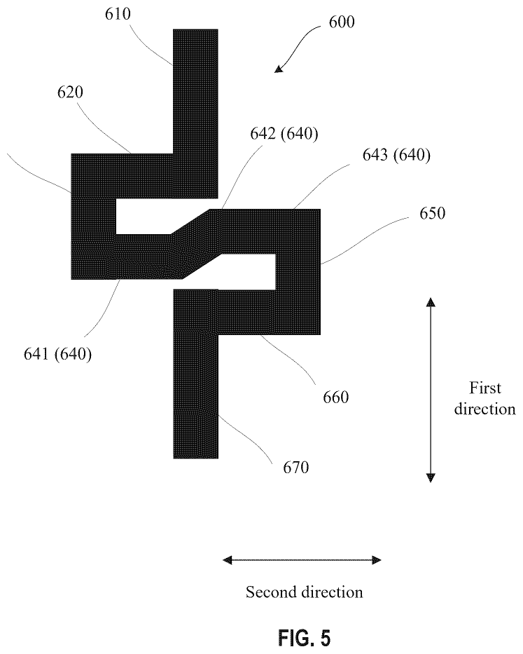

FIG. 5 is a schematic diagram of the structure of a bending axis disclosed in an embodiment of the present application;

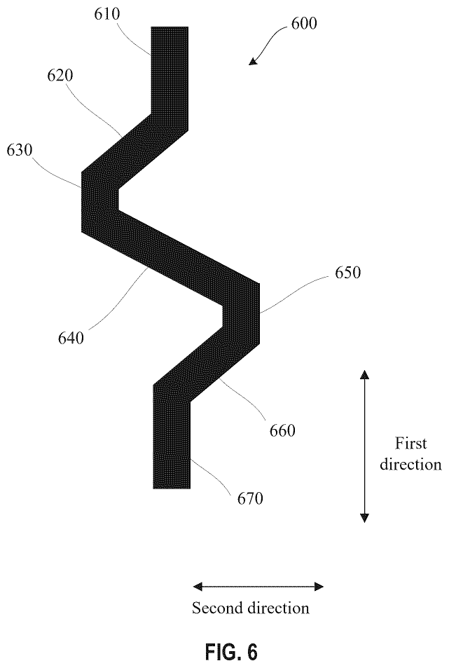

FIG. 6 is a schematic diagram of the structure of a bending axis disclosed in an embodiment of the present application;

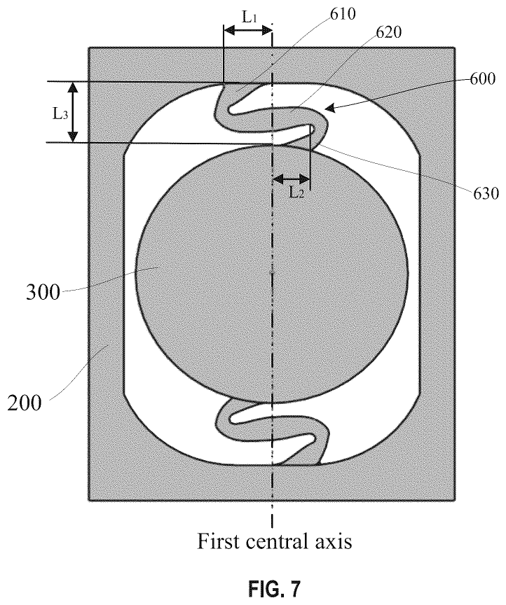

FIG. 7 is a schematic diagram of the structure of a galvanometer disclosed in an embodiment of the present application;

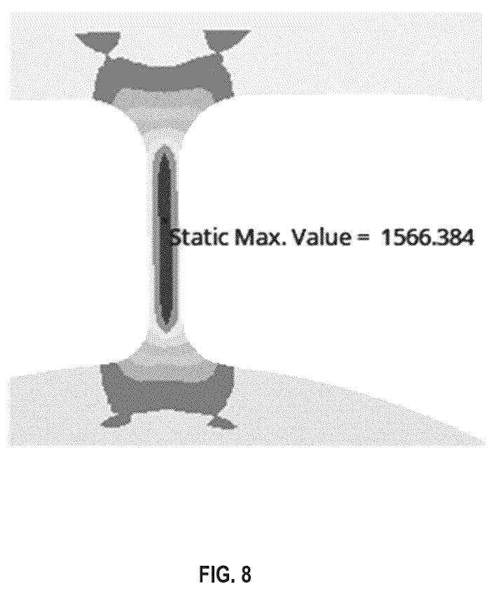

FIG. 8 is a stress distribution diagram obtained by numerical simulation of a galvanometer (using a straight axis);

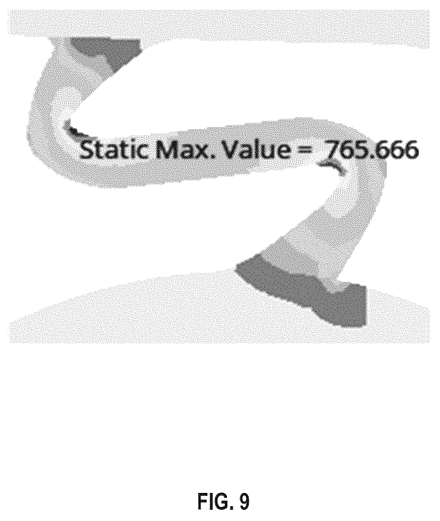

FIG. 9 is a stress distribution diagram obtained by numerical simulation of a galvanometer (using a bending axis, and the width of each segment of the bending axis is uniform);

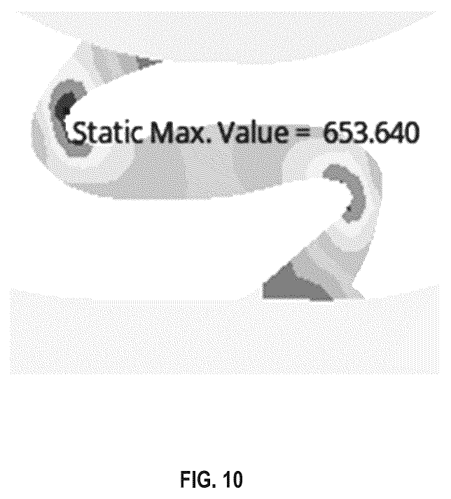

FIG. 10 is a stress distribution diagram obtained by numerical simulation of a galvanometer (using a bending axis, and each segment of the bending axis has a width change); and

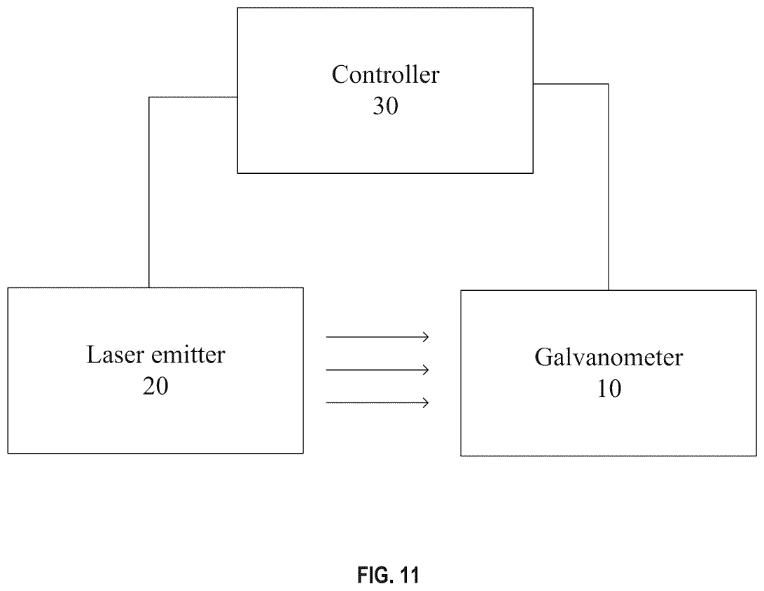

FIG. 11 is a schematic diagram of a LiDAR in an embodiment of the present application (the arrow in the figure represents laser beams).

Reference signs: 10, galvanometer; 100, fixed base; 101, first hollow area; 200, support frame; 201, second hollow area; 300, reflector; 400, first axis; 500, second axis; 600, bending axis; 610, first segment; 620, second segment; 630, third segment; 640, fourth segment; 641, first sub-segment; 642, second sub-segment; 643, third sub-segment; 650, fifth segment; 660, sixth segment; 670, seventh segment; 20, laser emitter; 30, controller.

### DETAILED DESCRIPTION

In order to make the objectives, technical solutions and advantages of the present application clearer, the present application is further described in detail in conjunction with the accompanying drawings and embodiments. It should be understood that the specific embodiments described herein are only used to explain the present application and are not used to limit the present application.

In the description of the present application, there might be the terms “upper,” “lower,” “left,” “right,” and the like that indicate the orientation or position relationship based on the orientation or position relationship shown in the accompanying drawings. These terms are only for the convenience of describing the present application and simplifying the description, rather than indicating or implying that the devices or components referred to must have a specific orientation or be constructed and operated in a specific orientation. Therefore, the terms describing the position relationship in the accompanying drawings are only used for exemplary explanations and cannot be interpreted as limitations on the present disclosure. For ordinary technicians in the field, the specific meanings of the above terms can be understood according to the specific circumstances.

In addition, the terms “first” and “second” are only used for descriptive purposes and cannot be interpreted as implying or suggesting relative importance or implicitly indicating the number of technical features indicated. Therefore, the features defined as “first” and “second” may explicitly or implicitly include one or more of the features. In the description of the present application, “a plurality of” means at least two, such as two, three, etc., unless otherwise clearly and specifically defined.

In the description of the present application, unless otherwise clearly specified and defined, the terms such as “install,” “attach,” “connect,” “fix,” and similar expressions should be interpreted broadly. For example, it can be a fixed connection, a detachable connection, or a whole; it can be a mechanical connection or an electrical connection; it can be directly connected or indirectly connected through an intermediate medium; and it can be the internal connection of two components or the interaction relationship between two components, unless otherwise clearly defined. For ordinary technicians in the field, the specific meanings of the above terms in the present application can be understood according to the specific circumstances.

It should be noted that when a component is referred to as “fixed on” or “disposed on” another component, it can be directly on the other component or there can also be a component in between. When a component is considered to be “connected” to another component, it can be directly connected to the other component or there may be a component in between at the same time. The terms “vertical,” “horizontal,” “upper,” “lower,” “left,” “right,” and similar expressions used in the present application are for illustrative purposes only and do not represent the only implementation method.

LiDAR is a radar system that emits laser beams to detect the position, speed, and other characteristic quantities of target objects. In recent years, the application of galvanometers in LiDAR has become a development trend. A galvanometer is a micro-mirror with advantages such as small size, high oscillation frequency, and without rotating components.

With the widespread application of LiDAR, higher demands are being placed on its performance, such as the need to achieve larger scanning field of view and longer detection ranges, which requires the galvanometer to provide larger torsion angles and larger optical apertures. However, a large optical aperture means that the size of the reflector is increased, the structural stress of the torsion axis is large, and a larger torsion angle also means a greater structural stress. These factors will affect the reliability of the galvanometer.

In a first aspect, an embodiment of the present application provides a galvanometer, which is intended to make the galvanometer have better reliability when providing larger torsion angles.

As shown in FIG. 1, FIG. 2, and FIG. 3, in an embodiment of the present application, the galvanometer 10 includes a fixed base 100, a support frame 200, and a reflector 300. The fixed base 100 has a first hollow area 101, the support frame 200 is arranged in the first hollow area 101, and the support frame 200 is connected to the fixed base 100 through a first axis 400. The support frame 200 is provided with a second hollow area 201, the reflector 300 is provided in the second hollow area 201, and the reflector 300 is connected to the support frame 200 through a second axis 500. At least one of the first axis 400 and the second axis 500 is a bending axis 600.

The fixed base 100 is configured to fix and install the entire galvanometer 10 structure, and the first hollow area 101 in the fixed base 100 is configured to accommodate the moving part of the galvanometer 10. The support frame 200 and the reflector 300 constitute the moving part of the galvanometer 10, and the reflector 300 is configured to reflect the laser beams. When the LiDAR is working, the support frame 200 is twisted relative to the fixed base 100, and the reflector 300 is twisted relative to the support frame 200, so that the reflector 300 deflects the laser beams to scan various positions in the field of view. In general, coils are provided on the support frame 200 and/or the reflector 300, and the galvanometer 10 is set in an external magnetic field. When the coils are energized, Lorentz forces are generated, which drives the support frame 200 and the reflector 300 to deflect in the magnetic field, and the changing electrical signal in the coils drive the support frame 200 and the reflector 300 to continuously reciprocate.

The first axis 400 is configured to connect the support frame 200 and the fixed base 100, and the second axis 500 is configured to connect the fixed base 100 and the galvanometer 10, where the first axis 400 can also be called a slow axis, and the second axis 500 can also be called a fast axis.

The galvanometer 10 in the related technology, the fast axis and the slow axis are both straight axes, so that the lengths of the fast axis and the slow axis are both short. The stress calculation formula of an axis structure in the torsion state is:

τₘₐₓ=Gbθα/L
τₘₐₓ represents the maximum stress of an axis, G is the shear modulus, b is the thickness of an axis, θ is the torsion angle of an axis, α is a coefficient related to the width and thickness of an axis, and L is the total length of an axis.

From the above formula, it can be seen that the maximum stress borne by an axis is inversely proportional to the total length of the axis. Therefore, by increasing the total length of an axis, the maximum stress borne by the axis can be reduced.

In an embodiment of the present application, at least one of the first axis 400 and the second axis 500 of the galvanometer 10 is a bending axis 600. Without reducing the area of the reflector 300, the bending axis 600 has a longer length than the straight axis. Thus, the length of the first axis 400 and/or the second axis 500 can be increased. In this way, when the galvanometer 10 provides larger torsion angles, the structural stress borne by the first axis 400 and/or the second axis 500 can be reduced, thereby making the galvanometer 10 have better reliability.

In some embodiments, as shown in FIG. 4, FIG. 5, and FIG. 6, the bending axis 600 includes a first segment 610, a second segment 620, a third segment 630, a fourth segment 640, a fifth segment 650, a sixth segment 660, and a seventh segment 670 connected in sequence. The first segment 610, the third segment 630, the fifth segment 650, and the seventh segment 670 are all straight segments and extend along the first direction. Along the first direction, the third segment 630 and the fifth segment 650 are both located between the first segment 610 and the seventh segment 670. Along the second direction, the first segment 610 and the seventh segment 670 are both located between the third segment 630 and the fifth segment 650, and the second direction is perpendicular to the first direction.

In an embodiment, the bending axis 600 includes seven segments, where the first segment 610, the third segment 630, the fifth segment 650, and the seventh segment 670 are all straight segments and extend along the first direction. In addition, along the first direction, the third segment 630 and the fifth segment 650 are located between the first segment 610 and the seventh segment 670; along the second direction, the first segment 610 and the seventh segment 670 are located between the third segment 630 and the fifth segment 650. The first segment 610 and the third segment 630 are connected by the second segment 620, the third segment 630 and the fifth segment 650 are connected by the fourth segment 640, and the fifth segment 650 and the seventh segment 670 are connected by the sixth segment 660. In this way, the bending axis 600 presents a meandering structure. Thus, the bending axis 600 is significantly increased in length compared to a straight axis. Accordingly, when the galvanometer 10 provides larger torsion angles, the structural stress borne by the bending axis 600 can be significantly reduced, thereby significantly improving the reliability of the galvanometer 10.

In an embodiment, as shown in FIG. 4, the second segment 620, the fourth segment 640, and the sixth segment 660 are all straight segments and extend along the second direction.

Typically, the fast axis and the slow axis of the galvanometer 10 are both made by photolithography. In the photolithography process, the straight segment is easier to control in morphology, so it is conducive to reducing the morphology deviation after molding. Therefore, constructing the second segment 620, the fourth segment 640, and the sixth segment 660 as straight segments is conducive to improving the molding accuracy of the bending axis 600.

In an embodiment, as shown in FIG. 5, the second segment 620 and the sixth segment 660 are both straight segments and extend along the second direction. The fourth segment 640 includes a first sub-segment 641, a second sub-segment 642, and a third sub-segment 643 connected in sequence, where the first sub-segment 641 is connected to the third segment 630, and the third sub-segment 643 is connected to the fifth segment 650. The first sub-segment 641 and the third sub-segment 643 are straight segments and extend along the second direction. Along the first direction, the third sub-segment 643 is located between the second segment 620 and the first sub-segment 641.

In an embodiment, the second segment 620, the sixth segment 660, the first sub-segment 641, and the third sub-segment 643 are all straight segments, which is conducive to reducing the morphology deviation after photolithography molding. Furthermore, the fourth segment 640 includes a first sub-segment 641, a second sub-segment 642, and a third sub-segment 643 connected in sequence. Along the first direction, the third sub-segment 643 is located between the second segment 620 and the first sub-segment 641, in other words, the third sub-segment 643 is closer to the second segment 620 than the first sub-segment 641. Compared with the fourth segment 640 which adopts a straight segment as a whole, the length of the bending axis 600 along the first direction can be reduced while the total length of the bending axis 600 remains unchanged. In this way, a larger reflector 300 can be set to increase the reflection area.

Further, the second sub-segment 642 is a straight segment, and the angle between the second sub-segment 642 and the first sub-segment 641 is greater than or equal to 135° and less than or equal to 165°. If the angle between the second sub-segment 642 and the first sub-segment 641 is too large, the effect of reducing the length of the bending axis 600 along the first direction will be less obvious. If the angle between the second sub-segment 642 and the first sub-segment 641 is too small, it is easy to cause a load effect during the etching process, resulting in uneven etching. After repeated tests and verifications, it was found that when the angle between the second sub-segment 642 and the first sub-segment 641 is greater than or equal to 135° and less than or equal to 165°, the reduction in the length of the bending axis 600 along the first direction will be more obvious, and it is not easy to cause a load effect during etching.

In some embodiments, the connection parts between any two adjacent segments are formed with rounded corners. By forming the connection parts between adjacent components with rounded corners, the stress concentration phenomenon at the connection parts can be weakened or avoided.

In some embodiments, the minimum distance between the second segment 620 and the fourth segment 640 along the first direction is not less than 25 μm. Refer to FIG. 4, for an embodiment in which the fourth segment 640 is a straight segment, the distance between each part of the second segment 620 and the fourth segment 640 is equal. Therefore, the distance between the second segment 620 and the fourth segment 640 is equal to the minimum distance between them along the first direction. Refer to FIG. 5, for an embodiment in which the fourth segment 640 includes the first sub-segment 641, the second sub-segment 642 and the third sub-segment 643, the third sub-segment 643 is closer to the second segment 620 than the first sub-segment 641 and the second sub-segment 642. Therefore, the minimum distance between the second segment 620 and the fourth segment 640 along the first direction is equal to the distance between the third sub-segment 643 and the second segment 620.

The connection part of the second segment 620 and the third segment 630, and the connection part of the third segment 630 and the fourth segment 640 are formed with a rounded corner. The larger the rounded corner radius of the above-mentioned rounded corner, the better the effect of weakening stress concentration, and the size of the rounded corner radius is limited by the distance between the second segment 620 and the fourth segment 640. In other words, when the distance between the second segment 620 and the fourth segment 640 is large, the rounded corner half angle of the above-mentioned rounded corner can be set relatively large. After a large number of experimental verifications, it was found that it is necessary to ensure that the distance between the second segment 620 and the fourth segment 640 along the first direction is not less than 25 μm, so as to ensure that the rounded corner of the connection part of the second segment 620 and the third segment 630, and the rounded corner of the connection part of the third segment 630 and the fourth segment 640 have sufficient rounded corner radius, so as to obtain a more obvious effect of weakening stress concentration.

In some embodiments, the minimum distance between the fourth segment 640 and the sixth segment 660 along the first direction is not less than 25 μm. Refer to FIG. 4, for an embodiment in which the fourth segment 640 is a straight segment, the distance between each part of the sixth segment 660 and the fourth segment 640 is equal. Therefore, the distance between the sixth segment 660 and the fourth segment 640 is equal to the minimum distance between them along the first direction. Refer to FIG. 5, for an embodiment in which the fourth segment 640 includes a first sub-segment 641, a second sub-segment 642, and a third sub-segment 643, the first sub-segment 641 is closer to the sixth segment 660 than the second sub-segment 642 and the third sub-segment 643. Therefore, the minimum distance between the sixth segment 660 and the fourth segment 640 along the first direction is equal to the distance between the first sub-segment 641 and the sixth segment 660.

The connection part of the sixth segment 660 and the fifth segment 650, and the connection part of the fifth segment 650 and the fourth segment 640 are formed with a rounded corner. The larger the rounded corner radius of the above-mentioned rounded corner, the better the effect of weakening stress concentration, and the size of the rounded corner radius is limited by the distance between the sixth segment 660 and the fourth segment 640. In other words, when the distance between the sixth segment 660 and the fourth segment 640 is large, the rounded corner half angle of the above-mentioned rounded corner can be set relatively large. After a large number of experimental verifications, it was found that it is necessary to ensure that the distance between the fourth segment 640 and the sixth segment 660 along the first direction is not less than 25 μm, so as to ensure that the rounded corner of the connection part of the sixth segment 660 and the fifth segment 650, and the rounded corner of the connection part of the fifth segment 650 and the fourth segment 640 have sufficient rounded corner radius, so as to obtain a more obvious effect of weakening stress concentration.

Further, the minimum distance between the second segment 620 and the fourth segment 640 along the first direction is not less than 50 μm. After a large number of experimental verifications, it was found that when the minimum distance between the second segment 620 and the fourth segment 640 along the first direction is not less than 50 μm, the stress concentration at the connection part between the second segment 620 and the third segment 630, and the connection part between the third segment 630 and the fourth segment 640 will be significantly weakened.

Further, the minimum distance between the fourth segment 640 and the sixth segment 660 along the first direction is not less than 50 μm. After a large number of experimental verifications, it was found that when the minimum distance between the fourth segment 640 and the sixth segment 660 along the first direction is not less than 50 μm, the stress concentration at the connection part between the sixth segment 660 and the fifth segment 650, and at the connection part between the fifth segment 650 and the fourth segment 640 will be significantly weakened.

In an embodiment, as shown in FIG. 6, the second segment 620, the fourth segment 640, and the sixth segment 660 are all straight segments, the angle between the second segment 620 and the first segment 610 is greater than 90°, the angle between the fourth segment 640 and the third segment 630 is greater than 90°, the angle between the sixth segment 660 and the fifth segment 650 is greater than 90°, and the second segment 620 is parallel to the sixth segment 660.

It can be seen that the first segment 610, the third segment 630, the fifth segment 650, and the seventh segment 670 all extend along the first direction, the angle between the second segment 620 and the third segment 630 is also greater than 90°, the angle between the fourth segment 640 and the fifth segment 650 is also greater than 90°, and the angle between the sixth segment 660 and the seventh segment 670 is also greater than 90°. Thus, a bending axis 600 that is longer than a straight axis can also be constructed. This is conducive to reducing the structural stress borne by the first axis 400 and/or the second axis 500, so as to improve the reliability of the galvanometer 10.

In some embodiments, as shown in FIG. 7, the bending axis 600 includes a first segment 610, a second segment 620, and a third segment 630 connected in sequence, a first bending angle is formed between the first segment 610 and the second segment 620, a second bending angle is formed between the second segment 620 and the third segment 630, and the first bending angle and the second bending angle are both less than 90°.

In this way, the bending axis 600 as a whole presents a structure similar to an “S” shape. Thus, a bending axis 600 longer than a straight axis can also be constructed. This is conducive to reducing the structural stress borne by the first axis 400 and/or the second axis 500, so as to improve the reliability of the galvanometer 10.

Further, the galvanometer 10 has a first central axis, the first central axis passes through the center of the reflector 300, the first axis 400 extends along the first direction, and the first segment 610 and the third segment 630 are located on opposite sides of the first central axis. In other words, the first segment 610 and the third segment 630 are both set away from the first central axis. Such a setting is conducive to increasing the first bending angle and the second bending angle, where increasing the first bending angle can weaken the stress concentration phenomenon at the connection part between the first segment 610 and the second segment 620, and increasing the second bending angle can weaken the stress concentration phenomenon at the connection part between the second segment 620 and the third segment 630.

In some embodiments, the first segment 610 has a first end away from the reflector 300, the third segment 630 has a second end close to the reflector 300, the maximum distance between the first end and the first central axis is L₁, the maximum distance between the second end and the first central axis is L₂, and the length of the bending axis 600 along the first direction is L₃, then L₁, L₂, and L₃ satisfy the following relationship:

0.5L₃<L₁<L₃;

0.5L₃<L₂<L₃.

The above relational expressions define the degree of deviation of the first segment 610 relative to the first central axis, and the degree of deviation of the third segment 630 relative to the first central axis. After a large number of experimental verifications, it was found that when the above relational expressions are satisfied, the stress concentration at the connection part between the first segment 610 and the second segment 620, and the stress concentration at the connection part between the second segment 620 and the third segment 630 can be significantly weakened.

In an embodiment, the first segment 610, the second segment 620, and the third segment 630 are all segments with uniform width. In other words, the width of each position of the first segment 610 is equal, the width of each position of the second segment 620 is equal, and the width of each position of the third segment 630 is equal. In this way, the bending axis 600 is easy to process and form.

In an embodiment, refer to FIG. 7, the width of the first segment 610 gradually decreases from the end away from the second segment 620 to the end close to the second segment 620; the width of the third segment 630 gradually decreases from the end away from the second segment 620 to the end close to the second segment 620; and the width of the second segment 620 gradually decreases from the middle to both ends. After a lot of research, it was found that by constructing the first segment 610, the second segment 620, and the third segment 630 into the above-mentioned structural form, when the torsion angle of the reflector 300 is the same, the maximum stress of the bending axis 600 can be reduced.

FIGS. 8 to 10 are stress distribution diagrams obtained by numerical simulation using the finite element method. FIG. 8 shows the stress distribution when the galvanometer 10 adopts a straight axis. According to the results of the numerical simulation, when the straight axis rotates 20°, the maximum stress value is 1566 MPa. FIG. 9 and FIG. 10 are stress distribution diagrams when the galvanometer 10 adopts a bending axis 600 with an “S”-shaped structure. In the bending axis 600 in FIG. 9, the first segment 610, the second segment 620, and the third segment 630 have uniform widths. According to the results of the numerical simulation, when the bending axis 600 is twisted 20°, the maximum stress value is 765 MPa. In the bending axis 600 in FIG. 10, the width of the first segment 610 gradually decreases from the end away from the second segment 620 to the end close to the second segment 620; the width of the third segment 630 gradually decreases from the end away from the second segment 620 to the end close to the second segment 620; and the width of the second segment 620 gradually decreases from the middle to both ends. According to the results of numerical simulation, when the bending axis 600 is twisted by 20°, the maximum stress value is 653 MPa. It can be seen that by constructing the first segment 610, the second segment 620, and the third segment 630 into the above-mentioned width-varying structural form, the maximum stress borne by the bending axis 600 can be further reduced, thereby further improving the reliability of the galvanometer 10.

In some embodiments, the first axis 400 is a bending axis 600, and there are two first axes 400, and the two first axes 400 are symmetrical about the center of the reflector 300. In this way, when the support frame 200 is twisted in different directions relative to the fixed base 100, the force conditions of the two first axes 400 remain basically consistent.

In some embodiments, the second axis 500 is a bending axis 600, and there are two second axes 500, and the two second axes 500 are symmetrical about the center of the reflector 300. In this way, when the reflector 300 is twisted in different directions relative to the support frame 200, the force conditions of the two second axes 500 remain basically consistent.

In a second aspect, an embodiment of the present application provides a LiDAR, which includes the galvanometer 10 in any of the above embodiments.

In some embodiments, as shown in FIG. 11, the LiDAR can include a laser emitter 20 and a controller 30, where the laser emitter 20 is configured to emit laser beams, and the controller 30 is electrically connected to the laser emitter 20 and the galvanometer 10, and is configured to control the laser emitter 20 to emit the laser beams and control the deflection of the galvanometer 10.

In an embodiment of the present application, in the galvanometer 10 of the LiDAR, at least one of the first axis 400 and the second axis 500 is a bending axis 600. Without reducing the area of the reflector 300, the bending axis 600 has a larger length than the straight axis. Thus, the length of the first axis 400 and/or the second axis 500 can be increased. In this way, when the galvanometer 10 provides larger torsion angles, the structural stress borne by the first axis 400 and/or the second axis 500 can be reduced, thereby making the galvanometer 10 have better reliability.

The above contents are only exemplary implementation methods of the present application, but the protection scope of the present application is not limited thereto. Any technician familiar with the technical field can easily think of changes or substitutions within the technical scope disclosed in the present application, which should be included in the protection scope of the present application. Therefore, the protection scope of the present application should be based on the protection scope of the claims.

What is claimed is:

1. A galvanometer, comprising:
a fixed base having a first hollow area;
a support frame arranged in the first hollow area and connected to the fixed base through a first axis, wherein the support frame is provided with a second hollow area; and
a reflector arranged in the second hollow area and connected to the support frame through a second axis,
wherein at least one of the first axis and the second axis is a bending axis.

2. The galvanometer according to claim 1, wherein:
the bending axis includes a first segment, a second segment, a third segment, a fourth segment, a fifth segment, a sixth segment, and a seventh segment connected in sequence;
the first segment, the third segment, the fifth segment, and the seventh segment are all straight segments and extend along a first direction;
along the first direction, the third segment and the fifth segment are both located between the first segment and the seventh segment; and
along a second direction, the first segment and the seventh segment are both located between the third segment and the fifth segment, and the second direction is perpendicular to the first direction.

3. The galvanometer according to claim 2, wherein:
the second segment, the fourth segment, and the sixth segment are all straight segments and extend along the second direction.

4. The galvanometer according to claim 2, wherein:
the second segment and the sixth segment are both straight segments and extend along the second direction;
the fourth segment includes a first sub-segment, a second sub-segment, and a third sub-segment connected in sequence, wherein the first sub-segment is connected to the third segment, the third sub-segment is connected to the fifth segment, and the first sub-segment and the third sub-segment are straight segments and extend along the second direction; and
along the first direction, the third sub-segment is located between the second segment and the first sub-segment.

5. The galvanometer according to claim 4, wherein:
the second sub-segment is a straight segment, and an angle between the second sub-segment and the first sub-segment is greater than or equal to 135° and less than or equal to 165°.

6. The galvanometer according to claim 4, wherein:
connection parts between any two adjacent segments are formed with rounded corners.

7. The galvanometer according to claim 6, wherein:
the minimum distance between the second segment and the fourth segment along the first direction is not less than 25 μm; or
the minimum distance between the fourth segment and the sixth segment along the first direction is not less than 25 μm.

8. The galvanometer according to claim 6, wherein:
the minimum distance between the second segment and the fourth segment along the first direction is not less than 50 μm; or
the minimum distance between the fourth segment and the sixth segment along the first direction is not less than 50 μm.

9. The galvanometer according to claim 2, wherein:
the second segment, the fourth segment, and the sixth segment are all straight segments, an angle between the second segment and the first segment is greater than 90°, an angle between the fourth segment and the third segment is greater than 90°, and an angle between the sixth segment and the fifth segment is greater than 90°; and
the second segment is parallel to the sixth segment.

10. The galvanometer according to claim 1, wherein:
the bending axis includes a first segment, a second segment, and a third segment connected in sequence, wherein a first bending angle is formed between the first segment and the second segment, a second bending angle is formed between the second segment and the third segment, and the first bending angle and the second bending angle are both less than 90°.

11. The galvanometer according to claim 10, wherein:
the galvanometer has a first central axis, wherein the first central axis passes through the center of the reflector and extends along a first direction; and
the first segment and the third segment are located on opposite sides of the first central axis.

12. The galvanometer according to claim 11, wherein:
the first segment has a first end away from the reflector, the third segment has a second end close to the reflector, the maximum distance between the first end and the first central axis is L₁, the maximum distance between the second end and the first central axis is L₂, and a length of the bending axis along the first direction is L₃, wherein L₁, L₂, and L₃ satisfy the relationship:
0.5L₃<L₁<L₃; and
0.5L₃<L₂<L₃.

13. The galvanometer according to claim 10, wherein:
a width of the first segment gradually decreases from an end away from the second segment to an end close to the second segment;
a width of the third segment gradually decreases from an end away from the second segment to an end close to the second segment; and
a width of the second segment gradually decreases from the middle to both ends.

14. A LIDAR, comprising a galvanometer, wherein the galvanometer comprises:
a fixed base having a first hollow area;
a support frame arranged in the first hollow area and connected to the fixed base through a first axis, wherein the support frame is provided with a second hollow area; and
a reflector arranged in the second hollow area and connected to the support frame through a second axis,
wherein at least one of the first axis and the second axis is a bending axis.
